(19) United States
(12) Patent Application Publication
(10) Pub. No.: US 2020/0206987 A1
(43) Pub. Date: Jul. 2, 2020

(54) HOT-PRESSING DEVICE

(71) Applicant: MAZDA MOTOR CORPORATION, Hiroshima (JP)

(72) Inventors: Takeshi MATSUDA, Hiroshima (JP); Masaru TOBO, Hiroshima (JP); Yuri TAKAHASHI, Hiroshima (JP); Kenji NAKAMURA, Hiroshima (JP); Yoshihide HIRAO, Toyota-shi (JP); Chie OKAWA, Hiroshima (JP); Seiji INOUE, Hiroshima (JP); Naoyuki IRIE, Hiroshima (JP)

(73) Assignee: MAZDA MOTOR CORPORATION, Hiroshima (JP)

(21) Appl. No.: 16/697,449

(22) Filed: Nov. 27, 2019

(30) Foreign Application Priority Data
Dec. 27, 2018 (JP) 2018-244613

(51) Int. Cl. B29C 43/36; B29C 43/52; B21D 22/02; B21D 37/16

(52) U.S. Cl. CPC B29C 43/36; B21D 37/16; B21D 22/022; B29C 43/52

(57) ABSTRACT

A hot-pressing device includes at least one mold having a molding surface; and at least one mold holder, wherein the hot-pressing device further comprises a refrigerant supply groove provided so as to horizontally extend to at least a mold side or a mold holder side in a contact surface between the at least one mold and the at least one mold holder; and at least one refrigerant supply path opened in corresponding at least one opening disposed on the molding surface, the refrigerant supply path communicating with the refrigerant supply groove and being provided in the inside of the at least one mold so as to extend vertically.

### CROSS-REFERENCE TO RELATED APPLICATION

This application claims priority to Japanese Patent Application No. 2018-244613 filed on Dec. 27, 2018, the entire disclosure of which is incorporated by reference herein.

### BACKGROUND

The present disclosure relates to a hot-pressing device.

As described in WO 2012/161192 (Patent Document 1) and Japanese Unexamined Patent Publication No. 2005-169394 (Patent Document 2), a direct water-cooled mold has been conventionally used in hot press molding.

However, in the Patent Documents 1 and 2, there is a problem in that it is necessary to form horizontal paths and vertical paths for supplying a refrigerant to the inside of a mold and a mold holder. Thus, time and cost are required for processing the mold and the mold holder. In particular, the case of forming horizontal paths and vertical paths inside the mold involves a problem in that the strength of the mold may be reduced when the number of the horizontal paths and the vertical paths is increased according to the shape of the work piece.

### SUMMARY

Hence, an object of the present disclosure is to provide a hot-pressing device that can reduce an excess decrease in strength of a mold while securing excellent cooling efficiency for a work piece and can reduce time and cost required for processing the mold and a mold holder.

In order to solve the above problems, the hot-pressing device disclosed herein includes at least one mold having a molding surface; and at least one mold holder, wherein the hot-pressing device further comprises a refrigerant supply groove provided so as to horizontally extend to at least a mold side or a mold holder side in a contact surface between the at least one mold and the at least one mold holder; and at least one refrigerant supply path opened in corresponding at least one opening disposed on the molding surface, the refrigerant supply path communicating with the refrigerant supply groove and being provided in the inside of the at least one mold so as to extend vertically.

In this configuration, at least one of the contact surface of the mold with the mold holder or the contact surface of the mold holder with the mold is provided with a horizontally extending groove such that the groove serves as a horizontal path. Thus, the number of horizontal paths inside the mold can be reduced without excessively reducing the entire number of refrigerant supply paths. Further, the sufficient strength of the mold can be secured while maintaining high cooling efficiency of the work piece by the refrigerant, and time and cost required for processing the mold can be reduced.

In one embodiment, the molding surface comprises at least one molding surface groove that is connected to the at least one opening of the at least one refrigerant supply path and guides a refrigerant supplied to the molding surface via the at least one opening.

The Patent Documents 1 and 2 disclose that a micro pattern having micrometer-sized projections on a molding surface of a mold is formed in order to increase cooling efficiency of a work piece. However, for example, the formation of a micro pattern as shown in FIG. 4 of the Patent Document 2 on a molding surface involves a problem in that a large amount of time and cost is required for processing. The inventors of the present invention conducted fluid simulation (CAE) analysis of a flow area for a refrigerant on a molding surface having a micro pattern as shown in FIG. 4 of the Patent Document 2 at the time when the refrigerant is jetted from jet holes 4 to the molding surface and found that the refrigerant does not flow into all gaps between the projections 13 but substantially radially flows into some of the gaps from the jet holes 4. This finding means that the gaps between the projections 13, not serving as flow areas for the refrigerant in the micro pattern are not necessary to be provided. In the above-described embodiment, the molding surface is provided with molding surface grooves for guiding a refrigerant, connected to the openings of paths instead of forming a conventional micro pattern. With this configuration, time and cost required for processing the molding surface can be significantly reduced while maintaining sufficient cooling efficiency.

In one embodiment, the molding surface comprises at least one discharge opening that is connected to the at least one molding surface groove and into which the refrigerant guided to the at least one molding surface groove flows, the at least one mold comprises at least one discharge path that is connected to the corresponding at least one discharge opening and from which the refrigerant flowed via the at least one discharge opening is discharged to the outside of the at least one mold, and a position of the at least one opening of the at least one refrigerant supply path is higher than that of the at least one discharge opening.

With this configuration, the refrigerant supplied to the molding surface via the openings are guided to the molding surface grooves, then flows into the discharge openings, and are discharged to the outside of the mold via the discharge paths. Further, the positions of the openings of the respective supply paths are higher than those of the discharge openings. This promotes the flow of the refrigerant guided to the molding surface groove.

In one embodiment, the refrigerant supply groove is provided on the mold holder side of the contact surface.

The mold has a molding surface and is thus required to have a high strength. Thus, in consideration of the material, the mold holder can have higher processability than that of the mold. This embodiment has a configuration of providing the mold holder with grooves and thus can facilitate processing and effectively reduce the reduction in the strength of the mold.

In one embodiment, the at least one opening on the molding surface comprises a plurality of openings, and a horizontal distance between adjacent openings is from 100 mm to 150 mm.

With this configuration, the horizontal distance between adjacent paths kept in a predetermined range allows high cooling efficiency of the work piece to be secured and an excess decrease in strength of the mold to be reduced. Moreover, an increase in time and cost required to process the mold can be reduced.

In one embodiment, the at least one mold comprises an upper mold and a lower mold, the at least one mold holder comprises an upper mold holder for holding the upper mold and a lower mold holder for holding the lower mold, and a shortest horizontal distance between the at least one opening disposed on the molding surface of the upper mold and the at least one opening disposed on the molding surface of the lower mold is from 40 mm to 80 mm.

With this configuration, the openings for supplying a refrigerant, of the upper mold and the openings for supplying a refrigerant, of the lower mold are disposed at positions offset from each other by the predetermined horizontal distance, and the entire work piece thus can be cooled evenly through cooling from the upper surface side of the work piece and the lower surface side of the work piece.

### BRIEF DESCRIPTION OF THE DRAWINGS

FIG. 1 is a cross-sectional view schematically illustrating a hot-pressing device according to a first embodiment of the present disclosure.

FIG. 2 is a plan view schematically illustrating a part of an upper mold.

FIG. 3 is a cross-sectional perspective view along line A-A of FIG. 2.

FIG. 4 is a perspective view schematically illustrating a contact surface on a lower mold holder side.

FIG. 5 is a plan view schematically illustrating a part of a lower mold.

FIG. 6 is a cross-sectional view along line B-B of FIG. 5.

FIG. 7 is an enlarged view of a part indicated by the symbol C in FIG. 6.

FIG. 8 is a cross-sectional view along line D-D of FIG. 7.

FIG. 9 is a cross-sectional view along line E-E of FIG. 7.

FIG. 10 is a cross-sectional view of a lower mold molding surface groove.

FIG. 11 is a cross-sectional view schematically illustrating parts of an upper mold, a work piece, and a lower mold during molding.

FIG. 12 is a diagram corresponding to FIG. 6 of the hot-pressing device according to the second embodiment.

### DETAILED DESCRIPTION

Embodiments of the present disclosure will now be described in detail with reference to the drawings. The following description of preferred embodiments is merely an example in nature, and is not intended to limit the scope, applications or use of the present disclosure.

### First Embodiment

### Hot-Pressing Device

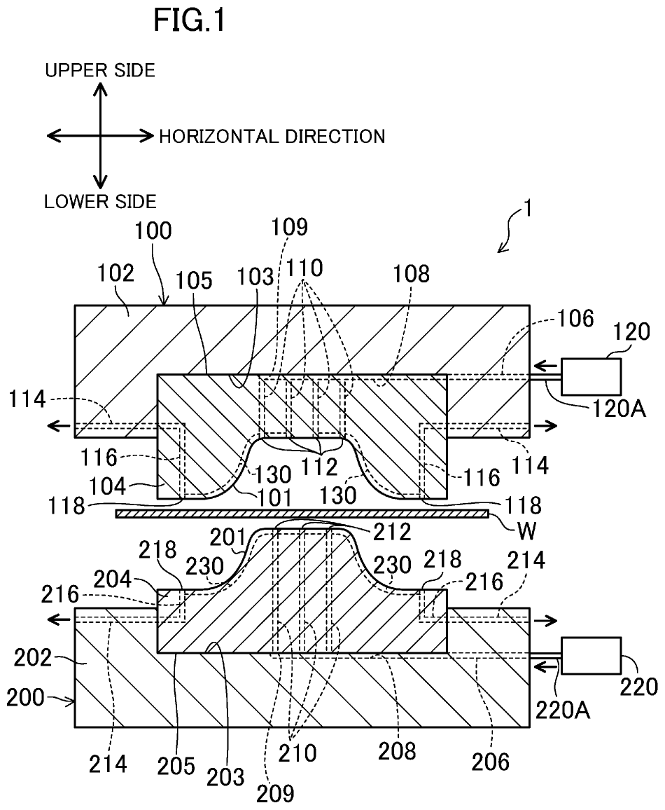

The hot-pressing device 1 shown in FIG. 1 includes an upper mold unit 100 and a lower mold unit 200. The hot-pressing device 1 is configured such that a heated work piece W is press-molded using a mold including the upper mold unit 100 and the lower mold unit 200 and is then cooled with a refrigerant such as water supplied to a molding surface of the mold in the pressed state to quench the work piece W.

In the present specification, the upper mold unit 100 side is referred to as the “upper side”, and the lower mold unit 200 side is referred to as the “lower side” as shown in FIG. 1. In addition, the “vertical direction” may be referred to as “vertically.” The direction perpendicular to the vertical direction may be referred to as “horizontally.”

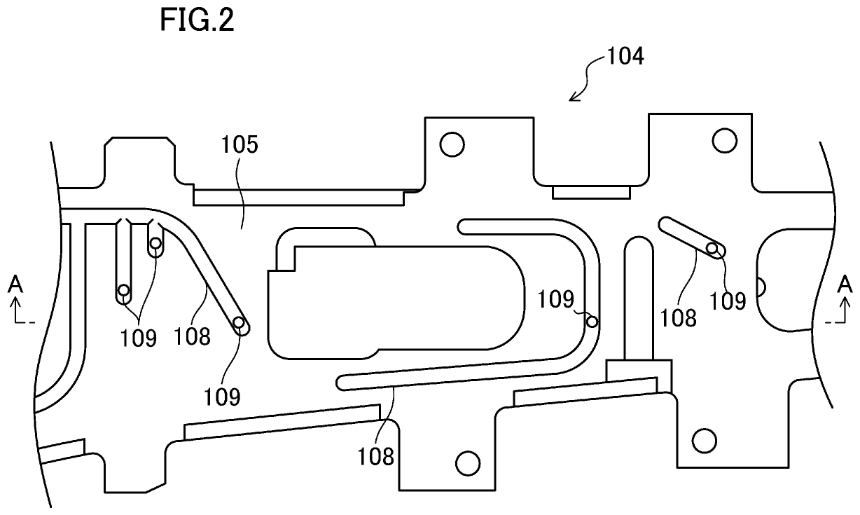

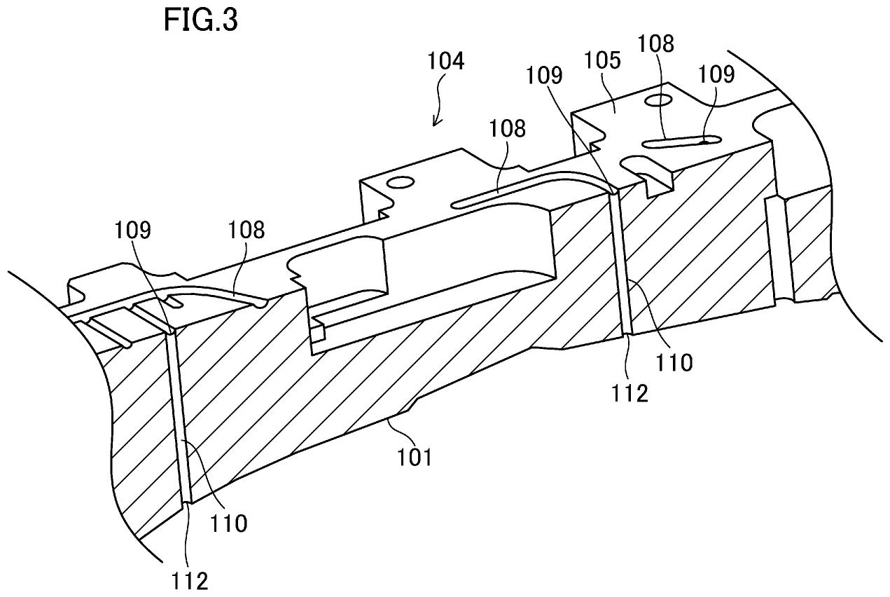

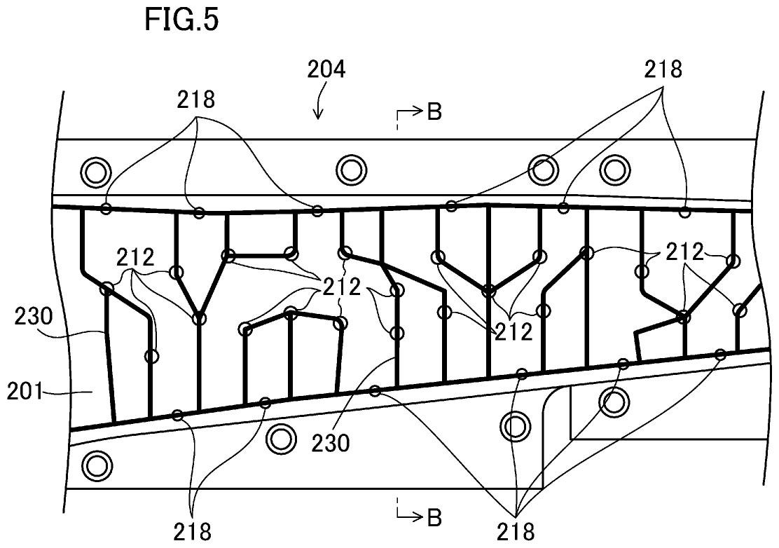

Each of the upper mold unit 100 and the lower mold unit 200 in the hot-pressing device 1 has a configuration of a mold in the present disclosure. Components of the hot-pressing device 1 according to the present embodiment will now be described with reference to FIGS. 1 to 10.

—Upper Mold Unit—

The upper mold unit 100 includes an upper mold 104 (mold) having an upper mold molding surface 101 (molding surface) and an upper mold holder 102 holding the upper mold 104. The upper mold 104 and the upper mold holder 102 are in contact with each other by an upper mold contact surface 105 (contact surface) and an upper mold holder contact surface 103 (contact surface). In addition, the upper mold unit 100 is movable and includes a slider (not shown). That is, by raising or lowering the slider, the upper unit 100 is shifted to a pressing position close to the lower mold unit 200 or a standby position apart from the lower mold unit 200 and on the upper side. In other words, the slider configures a position shift mechanism for shifting the upper mold unit 100 by the slider.

As shown in FIGS. 1 to 3, the upper mold contact surface 105 of the upper mold 104 is provided with a horizontally extending upper mold groove 108 (groove) for supplying a refrigerant. The inside of the upper mold 104 is provided with vertically extending upper mold paths 110 (paths) for supplying a refrigerant. The upper mold holder 102 sides of the upper mold paths 110 communicate with the upper mold groove 108 at the connection portion 109. The upper mold groove 108 is connected to a supply path 106 formed in the upper mold holder 102, and the supply path 106 is connected to the refrigerant supply unit 120 via a supply tube 120A. The upper mold molding surface 101 sides of the upper mold paths 110 have upper mold openings 112 (openings) disposed on the upper mold molding surface 101. The refrigerant supplied from the refrigerant supply unit 120 is supplied to the upper mold molding surface 101 via the supply tube 120A, the supply path 106, the upper mold groove 108, the upper mold paths 110, and the upper mold openings 112.

As shown in FIG. 1, the upper mold molding surface 101 is provided with upper mold molding surface grooves 130 (molding surface grooves) connected to the upper mold openings 112. The refrigerant supplied to the upper mold molding surface 101 via the upper mold openings 112 flows into the upper mold molding surface grooves 130. That is, the upper mold molding surface grooves 130 guide the refrigerant supplied to the upper mold molding surface 101 via the upper mold openings 112 in order to evenly cool the work piece W with the refrigerant.

The upper mold molding surface 101 is further provided with upper mold discharge openings 118 (discharge openings) into which the refrigerant supplied to the upper mold molding surface 101 flows. The upper mold discharge openings 118 are connected to the respective upper mold molding surface grooves 130. The upper mold 104 is provided with upper mold discharge paths 116 (discharge paths) connected to the respective upper mold discharge openings 118. The upper mold discharge paths 116 are further connected to the respective discharge paths 114 provided in the upper mold holder 102. The refrigerant flowed into the upper mold discharge paths 116 via the upper mold discharge openings 118 is discharged to the outside of the upper mold 104 via the discharge paths 114.

—Lower Mold Unit—

A lower mold unit 200 includes a lower mold 204 (mold) having a lower mold molding surface 201 (molding surface) and a lower mold holder 202 (mold holder) holding the lower mold. The lower mold 204 and the lower mold holder 202 are in contact with each other by a lower mold contact surface 205 (contact surface) and a lower mold holder contact surface 203 (contact surface). In addition, the lower mold unit 200 is fixed.

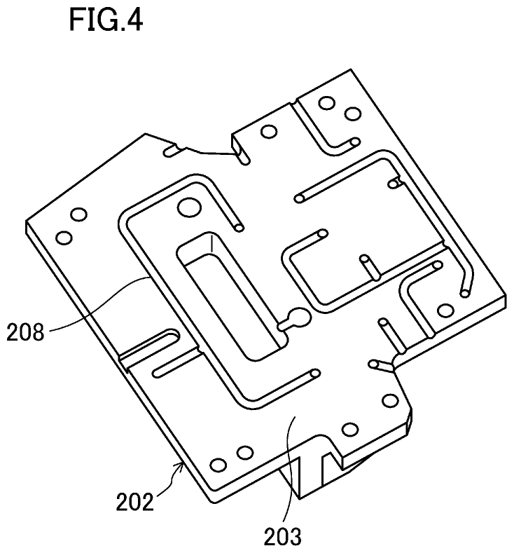

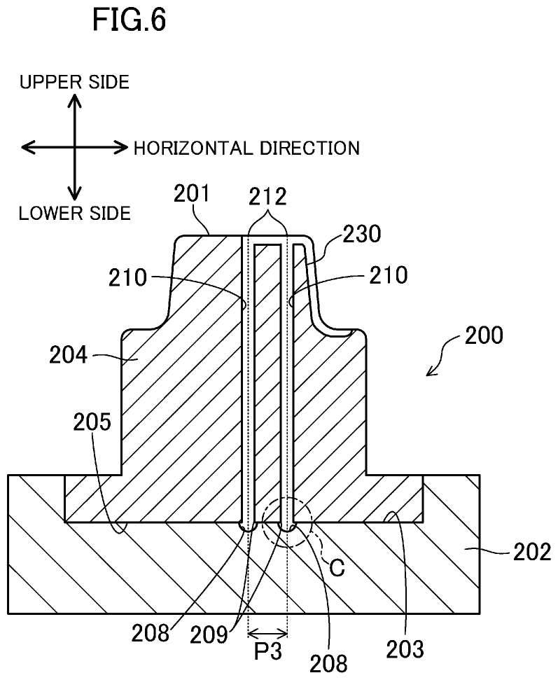

As shown in FIGS. 1 and 4, the lower mold holder contact surface 203 of the lower mold holder 202 is provided with a horizontally extending lower mold groove 208 (groove) for supplying a refrigerant. As shown in FIGS. 1 and 6, the inside of the lower mold 204 is provided with vertically extending lower mold paths 210 (paths) for supplying a refrigerant. The lower mold holder 202 sides of the lower mold paths 210 communicate with the lower mold groove 208 at the connection portion 209 of the lower mold contact surface 205. The lower mold groove 208 is connected to a supply path 206 formed in the lower mold holder 202, and the supply path 206 is connected to the refrigerant supply unit 220 via a supply tube 220A. The lower mold molding surface 201 sides of the lower mold paths 210 have lower mold openings 212 (openings) disposed on the lower mold molding surface 201. The refrigerant supplied from the refrigerant supply unit 220 is supplied to the lower mold molding surface 201 via the supply tube 220A, the supply path 206, the lower mold groove 208, the lower mold paths 210, and lower mold openings 212.

As shown in FIGS. 1, 5, and 6, the lower mold molding surface 201 is provided with lower mold molding surface grooves 230 (molding surface grooves) connected to the lower mold openings 212. The refrigerant supplied to the lower mold molding surface 201 via the lower mold openings 212 flows into the lower mold molding surface grooves 230. That is, the lower mold molding surface grooves 230 guide the refrigerant supplied to the lower mold molding surface 201 via the lower mold openings 212 in order to evenly cool the work piece W with the refrigerant.

The lower mold molding surface 201 is further provided with lower mold discharge openings 218 (discharge openings) into which the refrigerant supplied to the lower mold molding surface 201 flows. The lower mold discharge openings 218 are connected to the respective lower mold molding surface grooves 230. The lower mold 204 is provided with lower mold discharge paths 216 (discharge paths) connected to the respective lower mold discharge openings 218. The lower mold discharge paths 216 are further connected to the respective discharge paths 214 provided in the lower mold holder 202. The refrigerant flowed into the lower mold discharge paths 216 via the lower mold discharge openings 218 is discharged to the outside of the lower mold 204 via the discharge paths 214.

—Relationship of Vertical Positions of Openings Disposed on Molding Surface—

As shown in FIG. 1, the vertical position of each upper mold opening 112 of the corresponding upper mold path 110 is set so as to be higher than that of each upper mold discharge opening 118. As shown in FIGS. 1 and 6, the vertical position of each lower mold opening 212 of the corresponding lower mold path 210 is set so as to be higher than that of each lower mold discharge opening 218. According to this configuration, the refrigerant guided to the upper mold molding surface grooves 130 and the lower mold molding surface grooves 230 flows from a higher portion to a lower portion, so that the flow of the refrigerant can be promoted.

—Relationship of Horizontal Positions of Adjacent Openings Disposed on Molding Surface—

As shown in FIG. 6, the horizontal distance P3 between the adjacent lower mold openings 212 is preferably from 100 mm to 150 mm, more preferably from 110 mm to 130 mm. When the horizontal distance P3 is less than 100 mm, it becomes difficult to process the mold, time and cost are increased, and it may be difficult to secure a sufficient strength of the mold. When the horizontal distance P3 exceeds 150 mm, the amount of the refrigerant supplied to the lower mold molding surface 201 is insufficient, and the cooling efficiency of the work piece W may decrease.

Thus, the horizontal distance between adjacent lower mold paths 210 kept in the predetermined range allows a high cooling efficiency of the work piece W to be secured and an excess decrease in strength of the lower mold 204 to be reduced. Moreover, an increase in time and cost required to process the mold can be reduced.

In addition, the horizontal distance between the adjacent upper mold openings 112 may be the same as or similar to that of the lower mold openings 212.

—Configurations of Grooves, Paths, and Openings—

The shapes, sizes, and the like of the upper mold groove 108, the lower mold groove 208, the upper mold paths 110, the lower mold paths 210, the connection portion 109, the connection portion 209, the upper mold openings 112, the lower mold openings 212, the upper mold molding surface grooves 130, the lower mold molding surface grooves 230, the upper mold discharge openings 118, the lower mold discharge openings 218, the upper mold discharge paths 116, and the lower mold discharge paths 216 are the same as or similar to those in the upper mold unit 100 and the lower mold unit 200. An example of a configuration of the lower mold unit 200 will be described below.

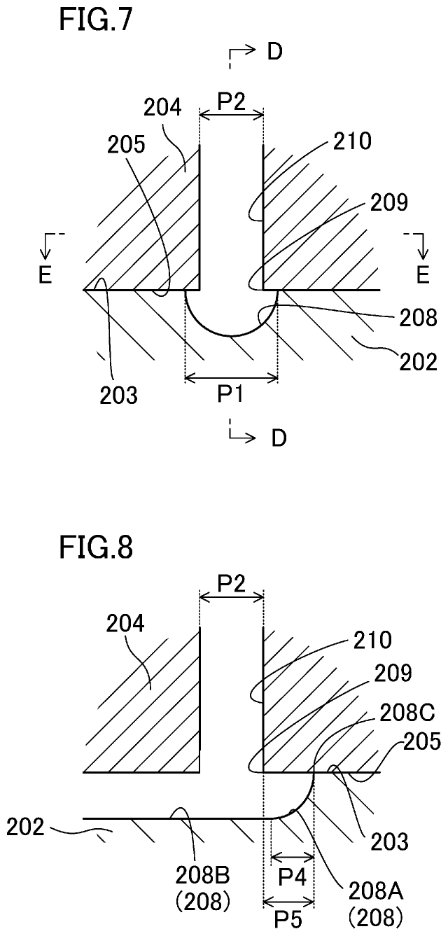

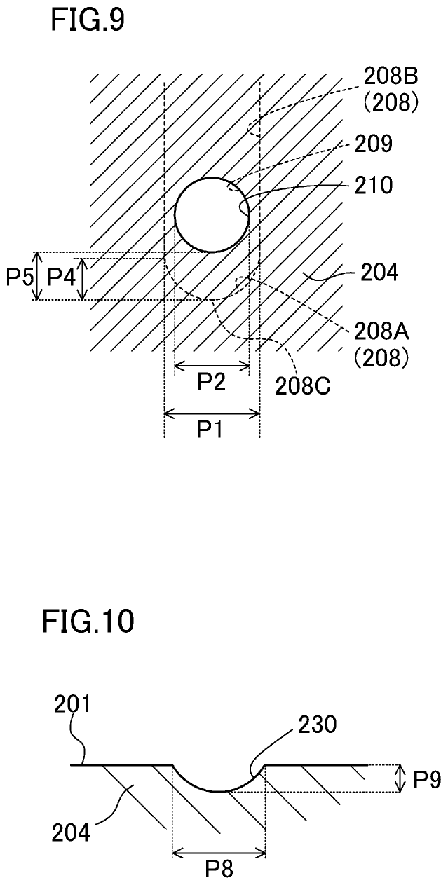

As shown in FIG. 6 and FIG. 7, each lower mold groove 208 is a semicircular groove having a diameter P1 or an arcuate groove having an arc length P1 in a cross section perpendicular to the direction for extending the lower mold groove 208. As shown in FIG. 9, the horizontal cross section of each lower mold path 210 has a circular shape having a diameter P2. In order to reliably communicate the lower mold grooves 208 and the lower mold paths 210, the diameter or arc length P1 of each lower mold groove 208 is set to be larger than the diameter P2 of each lower mold path 210. The diameter or arc length P1 of each lower mold groove 208 can be, for example, although not limited to, specifically from about 6 mm to about 12 mm. The diameter P2 of each lower mold path 210 can be, for example, although not limited to, specifically from about 4 mm to about 11 mm.

In addition, as shown in FIGS. 8 and 9, each lower mold groove 208 includes a lower mold groove end portion 208A and a lower mold groove main body 208B. The lower mold groove 208 is formed by scraping off the surface of the lower mold holder contact surface 203 using, for example, a drill or the like, and the lower mold groove end portion 208A may be formed in, for example, a curved surface shape. In the present embodiment, the positional relationship between the lower mold grooves 208 and the lower mold paths 210 is set such that the connection portion 209 is positioned in the lower mold groove main body 208B. In addition, the positional relationship between the lower mold grooves 208 and the lower mold paths 210 is not limited to the above-described configuration and may be set such that the connection portion 209 is positioned in the lower mold groove end portion 208A. That is, assuming that P4 represents the length of the lower mold groove end portion 208A, and P5 represents the shortest distance from the end 208C of the lower mold groove 208 to the connection portion 209, the shortest distance P5 may be, for example, 2 mm or more and may be larger than or smaller than the length P4.

The shape of the cross-sectional flow area of the lower mold molding surface groove 230 is not particularly limited. The shape is, for example, an arcuate shape as shown in FIG. 10. The maximum width P8 of the cross-sectional flow area of the lower mold molding surface groove 230 is not particularly limited. The maximum width P8 is desirably about 2 mm to about 6 mm in order to allow the refrigerant to spread throughout the lower mold molding surface groove 230 and reduce excessive deformation of the work piece W caused by the lower mold molding surface groove 230. The maximum depth P9 of the cross-sectional flow area of the lower mold molding surface groove 230 is not particularly limited. The maximum depth P9 is desirably 1 mm or less in order to allow the refrigerant to spread throughout the lower mold molding surface groove 230 and reduce excessive deformation of the work piece W caused by the lower mold molding surface groove 230.

The diameters of the lower mold openings 212, the lower mold discharge openings 218, and the lower mold discharge paths 216 are, for example, although not limited to be, the same as or similar to one another and specifically, for example, about 6 mm to about 13 mm.

—Relationship of Horizontal Positions of Upper Mold Openings and Lower Mold Openings—

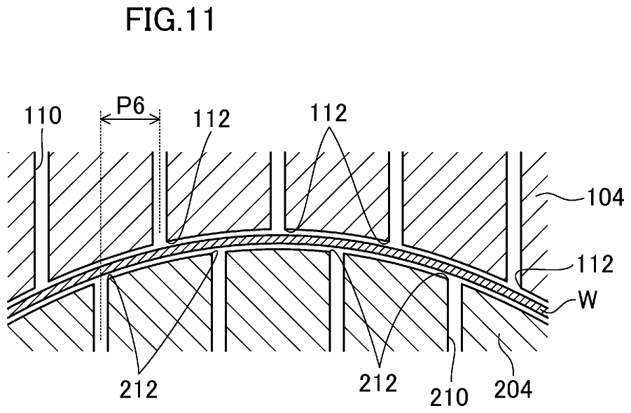

As shown in FIG. 11, the horizontal positions of the upper mold openings 112 and those of the lower mold openings 212 are not particularly limited. The horizontal positions are desirably offset. Specifically, the shortest horizontal distance P6 between the upper mold opening 112 and the lower mold opening 212 can be, for example, from 40 mm to 80 mm, preferably from 50 mm or more and 70 mm or less. With this configuration, the entire work piece W can be cooled evenly through cooling from the upper surface side of the work piece W and cooling from the lower surface side of the work piece W.

In addition, for example, in the case where a work piece W is required to be locally subjected to intensive cooling because of the requirements of the shape and the like of the work piece W, the upper mold openings 112 are disposed above a portion to be subjected to intensive cooling, the lower mold openings 212 are disposed below the portion, and the upper mold openings 112 can be brought horizontally close to the lower mold openings 212, i.e., the shortest distance P6 can be reduced. Then, the refrigerant is supplied to the portion to be subjected to intensive cooling from the upper side and the lower side. Thus, the portion can be subjected to intensive cooling. Further, in order to perform the intensive cooling, in addition to the adjustment of the positions of the upper mold openings 112 and those of the lower mold openings 212, a pitch of adjacent gaps between the upper mold molding surface grooves 130 and/or the lower mold molding surface grooves 230 at the portion may be reduced, or the number of the grooves may be increased.

### Advantages

In the hot-pressing device 1 according to the present embodiment, the contact surface between the upper mold 104 and the upper mold holder 102 and the contact surface between the lower mold 204 and the lower mold holder 202 are provided with grooves horizontally extending to the upper mold contact surface 105 and the lower mold holder contact surface 203 such that each groove serves as a horizontal path. With this configuration, the number of horizontal paths inside the upper mold 104 and the lower mold 204 can be reduced without excessively reducing the number of refrigerant supply paths in the entire mold.

Further, the upper mold molding surface 101 is provided with upper mold molding surface grooves 130 for guiding a refrigerant, connected to the upper mold openings 112, and the lower mold molding surface 201 is provided with lower mold molding surface grooves 230 for guiding the refrigerant, connected to the lower mold openings 212. With this configuration, time and cost required for processing the upper mold molding surface 101 and the lower mold molding surface 201 can be significantly reduced while maintaining sufficient cooling efficiency.

As described above, the hot-pressing device 1 according to the present embodiment can secure a sufficient strength of the mold while maintaining sufficient cooling efficiency by the refrigerant and can reduce time and cost required for processing the mold.

### Second Embodiment

Now, other embodiments according to the present disclosure will be described in detail. In addition, in descriptions of these embodiments, the same parts as those of the first embodiment are denoted by the same symbols, and detailed descriptions thereof are omitted.

For example, in the case where a piercing punch, a plunger, a panel positioning pin, a filling positioning key, or the like is disposed in the mold, straight upper mold paths 110 and straight lower mold paths 210 may not be provided vertically because of the configuration of the mold. In this case, horizontal paths may be provided as parts of the upper mold paths 110 and the lower mold paths 210.

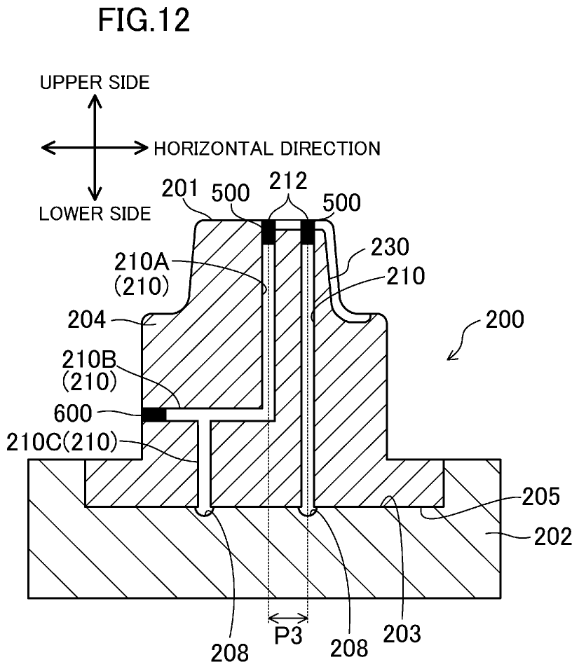

Specifically, for example, as shown in FIG. 12, some of the lower mold paths 210 may be configured to each include a horizontal path 210B formed in the lower mold 204. In this case, the lower mold path 210 may be configured by, for example, a first vertical path 210A on the lower mold molding surface 201 side, a horizontal path 210B, and a second vertical path 210C so as to circumvent a portion where paths cannot be formed. In addition, the horizontal path 210B may be formed so as to penetrate the side surface of the lower mold molding surface 201, for convenience in forming the horizontal path 210B in the lower mold 204. In this case, the opening formed in the side surface of the lower mold molding surface 201 can be closed by a plug member 600.

Even in the case where the horizontal path 210B is provided in a part of the lower mold path 210, the horizontal distance P3 between the adjacent lower mold openings 212 can be the same as or similar to that of the first embodiment.

Further, in order to adjust the discharge amount of the refrigerant supplied from the upper mold paths 110 and the lower mold paths 210 to the molding surface and to evenly discharge the refrigerant in all directions around the upper mold openings 112 and the lower mold openings 212, each of the upper mold openings 112 and the lower mold openings 212 may be provided with a fountain plug.

Specifically, as shown in FIG. 12, a fountain plug 500 is disposed in each lower mold opening 212. As the fountain plug 500, for example, a commercially available screw plug having a hole formed to have a desired diameter or the like can be used. With this configuration, by a simple operation of forming a hole in a screw plug, the discharge amount of the refrigerant can be adjusted, and the refrigerant can be discharged in all directions around the lower mold openings 212.

In addition, in the case where the fountain plug is provided, the diameters of the upper mold openings 112 and the lower mold openings 212 may be set to be larger than those of the upper mold paths 110 and the lower mold paths 210 in accordance with the outer diameter of the fountain plug.

### Other Embodiments

In the above-described embodiments, the upper mold contact surface 105 is provided with the upper mold grooves 108. Alternatively, instead of or in addition to the upper mold contact surface 105, the upper mold holder contact surface 103 may be provided with the upper mold grooves 108.

Further, in the above-described embodiments, the lower mold holder contact surface 203 is provided with the lower mold grooves 208. Alternatively, instead of or in addition to the lower mold holder contact surface 203, the lower mold contact surface 205 may be provided with the lower mold grooves 208.

In addition, the mold has a molding surface and is thus required to have a high strength. Thus, in consideration of the material, the mold holder can have higher processability than that of the mold. Thus, the upper mold grooves 108 and the lower mold grooves 208 are formed desirably in the upper mold holder contact surface 103 and the lower mold holder contact surface 203 in order to facilitate processing and effectively reduce the reduction in the strength of the mold.

In the above-described embodiments of the present disclosure, both of the upper mold unit 100 and the lower mold unit 200 are provided with the configuration of the mold. In the case where one of the upper mold unit 100 or the lower mold unit 200 has the configuration of the mold in the present disclosure, the other may have a conventional configuration as shown in the Patent Documents 1 and 2.

### INDUSTRIAL APPLICABILITY

The present disclosure can provide a hot pressing device that can reduce an excess decrease in strength of a mold while securing excellent cooling efficiency for a work piece, and can reduce time and cost required for processing the mold and a mold holder. The hot-pressing device is really useful.

What is claimed is:

1. A hot-pressing device comprising at least one mold having a molding surface; and at least one mold holder, wherein
the hot-pressing device further comprises a refrigerant supply groove provided so as to horizontally extend to at least a mold side or a mold holder side in a contact surface between the at least one mold and the at least one mold holder; and
at least one refrigerant supply path opened in corresponding at least one opening disposed on the molding surface, the refrigerant supply path communicating with the refrigerant supply groove and being provided in the inside of the at least one mold so as to extend vertically.

2. The hot-pressing device of claim 1, wherein
the molding surface comprises at least one molding surface groove that is connected to the at least one opening of the at least one refrigerant supply path and guides a refrigerant supplied to the molding surface via the at least one opening.

3. The hot-pressing device of claim 2, wherein
the molding surface comprises at least one discharge opening that is connected to the at least one molding surface groove and into which the refrigerant guided to the at least one molding surface groove flows,
the at least one mold comprises at least one discharge path that is connected to the corresponding at least one discharge opening and from which the refrigerant flowed via the at least one discharge opening is discharged to the outside of the at least one mold, and
a position of the at least one opening of the at least one refrigerant supply path is higher than that of the at least one discharge opening.

4. The hot-pressing device of claim 1, wherein
the refrigerant supply groove is provided on the mold holder side of the contact surface.

5. The hot-pressing device of claim 1, wherein
the at least one opening on the molding surface comprises a plurality of openings, and
a horizontal distance between adjacent openings is from 100 mm to 150 mm.

6. The hot-pressing device of claim 1, wherein
the at least one mold comprises an upper mold and a lower mold,
the at least one mold holder comprises an upper mold holder for holding the upper mold and a lower mold holder for holding the lower mold, and
a shortest horizontal distance between the at least one opening disposed on the molding surface of the upper mold and the at least one opening disposed on the molding surface of the lower mold is from 40 mm to 80 mm.
